(19) United States
(12) Patent Application Publication
(10) Pub. No.: US 2011/0293862 A1
(43) Pub. Date: Dec. 1, 2011

(54) Single-Layer or Multilayer Tubular Food Packaging Film that can be Smoked and Air-Dried, and Method for the Manufacture Thereof

(75) Inventor: Jurgen Schiffmann, Hennef (DE)

(73) Assignee: Kuhne Anlagenbau GMBH, St. Augustin/Menden (DE)

(21) Appl. No.: 13/201,359

(22) PCT Filed: Oct. 27, 2009
(86) PCT No.: PCT/EP09/07681

§ 371 Date: Aug. 12, 2011

(30) Foreign Application Priority Data
Feb. 20, 2009 (DE) 10 2009 009 876.3

(51) Int. Cl. B32B 1/08; B29D 23/00

(52) U.S. Cl. 428/34.8; 264/573

(57) ABSTRACT

The present invention relates to a single-layer or multilayer tubular food packaging film that can be smoked and air-dried, in particular a sausage casing, for smoked and/or air-dried sausage or meat goods, wherein the polymer-based food film is manufactured of a homogeneous molten plastic material in a (co-)extrusion film blow molding plant by means of (co-)extruded plastics supplied to a nozzle of a blow head and biaxially stretched in the triple-bubble process, the homogeneous molten plastic material being produced of a plastic blend of PET or a blend of various PETs and PVOHs and/or PEBAs. The present invention moreover relates to a method for the manufacture of the food film.

The present invention relates to a single-layer or multilayer tubular food packaging film that can be smoked and air-dried, in particular a sausage casing for smoked and/or air-dried sausage or meat goods, wherein the polymer-based food film is manufactured of a homogeneous molten plastic material in a (co-)extrusion film blow molding plant by means of (co-)extruded plastics supplied to a nozzle of a blow head and biaxially stretched in the triple-bubble process, in accordance with the preamble of claim 1. The invention further relates to a method for the manufacture thereof in accordance with the preamble of claim 11.

Smokeable sausage casings are known from practice and from literature. Thus patent specification DE 199 42 835 A1 discloses a sausage casing of an artificial sausage casing material, for which purpose a gas and oxygen permeable, soft plastic material is employed. The sausage casing material described in DE 199 42 835 A1 has an irregularly curved sausage shape with welded longitudinal seams. This sausage casing is said to be smokeable and have a sufficiently high strength.

From patent specification DE 198 30 389 A1 there is furthermore known a film for foodstuffs that can be air-dried and smoked.

Patent specification DE 101 25 762 A1 moreover discloses a shaped article having an irregular outer contour which is produced from a once-folded web of film material of a weldable plastic in a welding and cutting machine for welding and cutting the material webs. This cut-welded shaped article is said to provide a smokeable sausage casing having a sufficiently high strength.

From patent specification DE 35 26 394 C2 a raw sausage casing is moreover known which is said to be produced of a binder-free spun fleece of at least one polyamide (in brief: PA) joined together into a hose in the longitudinal direction. This raw sausage casing is said to be smokeable.

Patent specification DE 35 26 394 C2 also makes reference to document DE 30 29 028 A1 which discloses a fiber fleece-reinforced artificial casing which is said to be smokeable. The fiber fleece used for this purpose may be formed on the basis of PA. Particularly suited spun fleeces are to be on the basis of PA and polypropylene (in brief: PP). The like spun fleeces are to be impregnated with a coating solution. Suitable coating materials in accordance with patent specification DE 30 29 028 A1 are, in turn, any film-forming polymers that may be applied in the form of a powder and subsequently thermally melted into a film. Suitable film-forming polymers furthermore are those which may be applied as a coating in the form of a molten mass, solution, suspension or dispersion and formed into a film by subsequent drying. Suitable coating materials mentioned are, i. a., molecular disperse or colloidal solutions or suspensions of various polymers or blends thereof such as, e.g., polyvinyl alcohol (in brief: PVOH).

Document DE 42 20 957 A1 discloses a packaging casing comprising a flexible carrier material provided with a foam layer. The coating material used for this purpose is to be fully saponified PVOH. The foam of this substance is said to be waterproof, grease-tight and substantially impermeable to oxygen, nitrogen and carbon dioxide. Merely water vapor may penetrate freely through the foam layer of fully saponified PVOH. Fully saponified PVOH is therefore said to be suited for sausage casings and in particular for raw sausages. Combinations of PVOH with other plastic dispersions are furthermore said to be conceivable.

On the other hand, document WO 00/75220 A1 discloses a film casing on the basis of an extruded, tubular blend of plastics consisting of PA and polyether block amide (in brief: PEBA). In practice, the blend mentioned does result in a higher water vapor and oxygen permeability or permeation as compared with traditional PA blends, and thus also in a limited smokeability. But in practice the desired and necessary surface dyeing of the sausage or meat goods is lacking entirely.

According to the applicant's practical experience, smokeability is highly dependent on the PEBA content which is, however, not sufficient even at high PEBA concentrations. It is a further drawback that PEBA is a costly and soft material. As a result, blends having a correspondingly high PEBA content do admit a certain degree of smokeability. On the one hand, however, owing to the high costs and particularly owing to the much too low rigidity and strength, gathering of the film which is required particularly for sausage goods is rendered difficult or even impossible. On the other hand, the poor dimensional stability forbids a use of this film casing for raw sausage or hard sausage and in particular for salami.

Patent specification DE 102 95 683 T5 in contrast discloses a sausage casing of a blend of PA and a low proportion of PVOH. Other than the film casing in accordance with document WO 00/75220 A1, this blend permits a certain, albeit non-optimum, surface dyeing of the sausage or meat goods. The required oxygen or gas permeability is, however, clearly too low. The water vapor permeability is higher as compared with PA or PA/PEBA blends, yet too low for a use as a smokeable food film. With this film structure, an improvement of surface dyeing and of the permeability to oxygen or water vapor and thus of the smokeability might only be achieved by drastically reducing the wall thickness. This would in turn, however, in a same degree have a negative effect on the rigidity and/or strength and thus on the gathering suitability, which is contrary to a use for raw or hard sausage.

Documents DE 103 02 960 A1, DE 103 20 327 A1 and DE 103 23 417 B3 finally disclose food casings which are equally based on PA. With the aim of improving smokeability, a plurality of additional components such as PVOH and PEBA are here partly admixed to the the base material PA. The resulting blend provides limited usefulness with regard to surface dyeing, oxygen and water vapor permeability for several applications in the sausage field. One drawback of this film structure, however, is the lack of rigidity and strength, for in this case no less than two soft components (PVOH, PEBA) are admixed to the relatively rigid base material PA in order to obtain smokeability and surface dyeing. Even an admixture of small quantities of the two additional components reduces the rigidity and/or strength of the film to a level that is too low for most applications. In addition, a higher admixture of the additional components or a reduction in wall thickness would be necessary in order to improve the insufficient smokeability and surface dyeing. This in turn negatively influences the gathering suitability as well as the strength that is required for most uses.

It is thus true that smokeable food casings on a polymer basis and particularly on the basis of PA with PVOH and PEBA are thus known from the prior art, however their low rigidity and thus poor gathering suitability, as well as a dimensional stability that is not satisfactory as a general rule, only allow for a limited range of use. In addition, the permeability to and absorption of water vapor that are too low for smoke absorption, and the excessively high level of costs on account of the relatively high price for PA and the higher material thickness required for the rigidity are only conditionally suitable for the intended purposes of use.

From the prior art the utilization of nettings, flexible carrier materials or spun fleeces is furthermore known in order to improve the mechanical properties of food films in large-series manufacture. However, particularly in the case of fiber fleeces or spun fleeces, these frequently have to be condensed or coated to thereby increase complexity. Their low rigidity can, however, not be increased sufficiently in this way, so that gathering is made much more difficult and gathering of small calibers without a netting in particular is rendered plainly impossible. Such known sausage casings accordingly have not been suited for automated further processing up to the present date.

It is therefore an object of the present invention to propose a single-layer or multilayer tubular food packaging film that can be smoked and air-dried, which may be produced in large quantities and in a cost-efficient manner from a molten plastic material in industrial mass production, wherein the food film achieves the core parameters such as smokeability—which is determined by the oxygen and water vapor permeability and by the oxygen and water vapor absorption—surface dyeing of the stuffing, rigidity and/or strength (dimensional stability) in the absence of compromises brought about by dependencies, and which is capable of subsequent further processing in an automated manner. It is a further object to specify a method appropriate for this purpose.

This object is achieved through the features of claim 1, and in terms of process technology through the features of claim 11.

What is being proposed in accordance with the invention is a single-layer or multilayer tubular food film that can be smoked and air-dried, in particular a sausage casing for smoked and/or air-dried sausage or meat goods, wherein the food film is manufactured of a homogeneous molten plastic material in a (co-)extrusion film blow molding plant by means of (co-)extruded plastics supplied to a nozzle of a blow head and biaxially stretched in the triple-bubble process, the homogeneous molten plastic material being produced of a plastic blend of polyethylene terephthalate (in brief: PET) or of a blend of various PETs and PVOHs and/or PEBAs.

Advantageously this not only allows for the first time the large-scale manufacture of smokeable, air-dryable, tubular food films for food packagings in the nozzle blast drawing process and subsequent biaxial stretching in the triple-bubble process, but it is possible to entirely do away with the nettings, flexible carrier materials or spun fleeces discussed in the foregoing, which are felt to be a particular disadvantage in large-series production. In a particularly advantageous manner it is additionally possible to substitute the known PA blends which have found only conditional use in the market because of their insufficient permeability and absorption values and because of their insufficient rigidity and their excessively high costs.

Various studies and tests involving the food film of the invention revealed several trends. Thus, a high PET content is essentially necessary for a good dimensional stability and rigidity. Other than PA-based blends, the high PET content does not detract from the desired high smoke permeability, surface dyeing of the stuffing, and the low adherence of stuffing. Namely, the smoke permeability paralleling the water vapor absorption and permeability as well as the surface dyeing are reduced clearly less by a high PET content than by similar PA composites. In addition, the adherence of stuffing is not increased unfavorably.

It was moreover found that the water vapor and smoke permeability may be improved substantially and at the same time the peelability may be optimized further by the addition of PEBA. The addition of PEBA does, however, not yet permit a final adjustment of the desired high oxygen or water vapor permeability and thus of the smoke permeability. Neither can surface dyeing be adjusted in a satisfactory manner solely by the addition of PEBA. In addition, dimensional stability and/or rigidity are degraded by an inappropriately apportioned addition of PEBA, resulting in a further tradeoff with regard to desired properties.

It was, however, surprisingly found that the further admixture of PVOH for the first time resulted in a plastic blend which exhibits the desired high water vapor permeability and thus also smoke permeability if the blend proportions are selected and apportioned in accordance with the invention. Moreover high surface dyeing and a substantially higher rigidity are hereby attained. In addition the adherence of stuffing is reduced further. Adjustability of the dimensional stability moreover remains optimum with the plastic blend of the invention.

The smokeable, air-dryable food film of the invention is particularly well suited for raw sausages such as, e.g., salami, and maintains contact with the stuffing without forming wrinkles even if the stuffing was filled in manually, i.e., without pressure or under only low pressure and without the use of appropriate filling machines.

Meat or sausage goods produced with the smokeable and air-dryable tubular food packaging film in accordance with the invention, such as raw sausages and in particular hard sausages or salami, for example, are excellently suited for smoking and particularly well suited for air-drying.

Advantageous developments of the food film of the invention are subject matter of the sub-claims.

Thus, in a first variant the plastic blend of the single-layer or multilayer smokeable and air-dryable tubular food packaging film may include
a proportion of PET or of a blend of various PETs from 50 to 99% (wt.), and
a proportion of PVOH from 1 to 50% (wt.);
   or in a second variant may include
a proportion of PET or of a blend of various PETs from 70 to 99% (wt.), and
a proportion of PEBA from 1 to 30% (wt.);
   or in a third variant may include
a proportion of PET or of a blend of various PETs from 20 to 98% (wt.),
a proportion of PVOH from 1 to 50% (wt.), and
a proportion of PEBA from 1 to 30% (wt.).

In a particularly advantageous embodiment, the plastic blend of the third variant includes
a proportion of PET or of a blend of various PETs from 55 to 90% (wt.), in particular from 60 to 75% (wt.),
a proportion of PVOH from 5 to 30% (wt.), in particular from 15 to 25% (wt.), and
a proportion of PEBA from 1 to 15% (wt.), in particular from 5 to 10% (wt.).

These embodiments of the invention for the first time permit a particularly simple manufacture of a smokeable, air-dryable, tubular food film in the nozzle blast drawing process with subsequent biaxial stretching in the triple-bubble process, which thus for the first time fully accommodates the requirements of a smokeable sausage casing, for example for salami and the like. This food film, i.e., this sausage casing or food film, achieves maximum water vapor absorption and smoke permeability, wherein apart from the oxygen permeability the water vapor permeability and absorption are also of importance for the smoking process. Concurrently a high rigidity is obtained which is crucial for a good gathering process. The good dimensional stability demanded for an optimum filling process is equally attained with this food film.

In addition, the demanded low adherence of stuffing and the good peelability which have a bearing on the later processing operations are readily obtained with the food film of the invention, for the base raw material PET—other than PA-based blends—practically does not enter into any adherence with the stuffing.

Finally, the desired high surface dyeing of the stuffing, in particular of the sausage goods, which makes for the typical optical appearance of smoked sausage goods, is also excellently obtained with the food film of the invention.

Moreover the food film may exhibit a film thickness in a range from 10 to 50 μm, preferably from 15 to 30 μm, in particular at a caliber of up to 150 mm, preferably at a caliber from 15 mm to 90 mm. It is thus possible to select a film thickness providing a sufficiently high strength and dimensional stability for the food casing of the invention.

In another embodiment the food film may exhibit a water vapor permeability of at least 1.5 kg/(m²·day) at a film thickness of 20 μm (measurement method: ISO 15106-1). The water vapor permeability is thus five to six times that of traditional, PA-based blends at a concurrently high rigidity. Such a high water vapor permeability allows an efficient and effective smoking of foodstuffs packaged with the food film of the invention.

The food film may moreover exhibit a water vapor absorption of at least 0.4% (wt.), preferably in a range from 0.4 to 1.1% (wt.). Such a high water vapor absorption in turn brings about a high efficiency in smokeability. In comparison, comparable PA-based blends only exhibit a water vapor absorption of about 0.1% (wt.), at costs that are at least 20 to 30% higher.

It is furthermore advantageous if the food film exhibits a modulus of elasticity in a range from 2,000 to 3,000 N/mm² (measurement method: ISO 527). In comparison, PA-based blends exhibit a modulus of elasticity of only 400 to 750 N/mm² (measurement method: ISO 527). Such a high modulus of elasticity is indicative of the high rigidity of the food film of the invention that is a precondition for the required gathering suitability. At the same time, the rigidity is a measure of an excellent strength of the food film which is about four to six times as high as that of the traditional, PA-based blends. It is thus possible to realize particularly small wall thicknesses of the food film of the invention. This in turn brings about the advantages not only of good smokeability but also optimum suitability of the food film for automated further processing.

At the same time the food film of the invention exhibits a very good dimensional stability, so that meat or sausage goods produced with it maintain a desired shape predetermined by the sausage casing particularly well after corresponding smoking steps and in a given case also after prolonged air-drying phases.

Accordingly, the food film of the invention is characterized by a particularly good gathering suitability allowing even for small calibers having a diameter of less than 30 mm, a ratio of extended length to gathered length of at least 100 m in the extended condition and 20 cm in the gathered condition.

In another embodiment the plastic blend may include at least one silicate. Hereby the water vapor and smoke permeability is increased considerably.

In addition the plastic blend may include at least one filler selected from a group consisting of corn starch, cellulose powder and micro glass beads. The addition of such a filler also results in a considerable increase in water vapor and smoke permeability.

The plastic blend may moreover include at least one filler selected from a group consisting of chalk, talcum, salts, and other mineral substances. Such an addition brings about an improvement of the permeability and absorption properties.

In terms of process technology, the object discussed in the foregoing is attained through the features of claim 11, with the above-discussed features and advantages applying analogously to the method of the invention.

Thus, in the method of the invention for the manufacture of a single-layer or multilayer tubular food film that can be smoked and air-dried, in particular a sausage casing for smoked and/or air-dried sausage or meat goods, the sausage or meat goods are filled into the food film prior to smoking and/or air-drying. This food film is manufactured of a homogeneous molten plastic material in the nozzle blast drawing process and under subsequent biaxial stretching in the triple-bubble process. The molten plastic material is furthermore produced of PET or a blend of various PETs and PVOHs and/or PEBAs.

Advantageous developments of the method of the invention are subject matter of the sub-claims, with all of the advantages mentioned for the food casing of the invention as discussed in the foregoing being analogously valid for the method of the invention.

Thus, a first, second or third variant of the plastic blend may be selected, wherein the first variant includes
a proportion of PET or of a blend of various PETs from 50 to 99% (wt.), and
a proportion of PVOH from 1 to 50% (wt.),
   the second variant includes
a proportion of PET or of a blend of various PETs from 70 to 99% (wt.), and
a proportion of PEBA from 1 to 30% (wt.),
   or the third variant includes
a proportion of PET or of a blend of various PETs from 20 to 98% (wt.),
a proportion of PVOH from 1 to 50% (wt.), and
a proportion of PEBA from 1 to 30% (wt.).

In a particularly advantageous embodiment of the method it is possible to supply, in order to manufacture the food film according to the third variant,
a proportion of PET or of a blend of various PETs from 55 to 90% (wt.), in particular from 60 to 75% (wt.),
a proportion of PVOH from 5 to 30% (wt.), in particular from 15 to 25% (wt.), and
a proportion of PEBA from 1 to 15% (wt.), in particular from 5 to 10% (wt.).

Thus, a film thickness of the food film may be adjusted in a range from 10 to 50 μm, preferably from 15 to 30 μm, in particular at a caliber of up to 150 mm, preferably at a caliber from 15 mm to 90 mm.

Furthermore the plastic blend may be selected such that the food film exhibits a water vapor permeability of at least 1.5 kg/(m²·day) at a film thickness of 20 μm.

In addition the plastic blend may be selected such that the food film exhibits a water vapor absorption of at least 0.4% (wt.), preferably in a range from 0.4 to 1.1% (wt.).

In another embodiment the plastic blend may be selected such that the food film exhibits a modulus of elasticity in a range from 2,000 to 3,000 N/mm².

In addition at least one silicate may be added to the plastic blend.

It is furthermore possible to add at least one filler selected from a group consisting of corn starch, cellulose powder and micro glass beads to the plastic blend.

Finally it is possible to add at least one filler selected from a group consisting of chalk, talcum, salts and other mineral substances to the plastic blend.

The preferred and further plastic blends described in the foregoing and further plastic blends were subjected to a number of studies and test series at the applicant's facilities in order to determine the optimum plastic blends for the manufacture of the smokeable, air-dryable, tubular food film of the invention for food packagings such as, e.g., sausage casings. To this end, suitable plastic blends were used to produce molten plastic materials, from which the food films were in turn manufactured in the nozzle blast drawing process. Subsequently the films were biaxially stretched in the triple-bubble process. Finally, the films manufactured and stretched in this way were examined with regard to the above-described properties.

In a preferred practical example of the smokeable, air-dryable food packaging film, the proportion of PET preferably is 60 to 75% (wt.). The proportion of PVOH is between 10 and 30% (wt.), preferably between 15 to 25% (wt.). Accordingly, in a given case a proportion of PEBA is 1 to 15% (wt.), preferably 5 to 10% (wt.). The mixing ratios thereby specified result in a particularly good food film for raw sausages.

The casing or film of the invention may be formed to be single- or multilayered.

It is moreover provided that natural smoke, liquid smoke or any other conceivable application form of smoke or smoke substitute substances is usable for smoking.

The aspects and advantages of the present invention discussed in the foregoing may best be obtained by making use of further synergy effects on an apparatus or system by the same applicant for the manufacture of tubular food films for food packagings such as, e.g., sausage casings, in the nozzle blast drawing process if the system for rapid cooling of thin thermoplastic tubes following their extrusion as disclosed in the patent specification DE 199 16 428 B4 to the same applicant is utilized additionally. In this regard it is also possible to consider a corresponding further development in accordance with patent specification DE 100 48 178 B4.

In this event the tubular film produced of the molten plastic material in the nozzle blow head is subjected to intense cooling in which the amorphous structure of the thermoplastic materials from the molten plastic material is preserved. The tubular film vertically extruded in the nozzle blow head from the molten plastic material initially travels into the cooling apparatus for being cooled without contacting the wall, as is described in detail in the patent specifications DE 199 16 428 B4 and DE 100 48 178 B4. With regard to details of the techniques and to the construction and the operation of this cooling means also referred to as a calibration means, the contents of DE 199 16 428 B4 and DE 100 48 178 B4 are hereby fully incorporated by way of reference in order to avoid repetitions.

In the cooling means, the tubular film then passes through support elements against which the film is supported due to a differential pressure between the inside of the tubular film and the cooling medium, wherein a liquid film is preserved between film and support elements to thereby preclude adhesion of the tubular film. The diameter of the support elements has a bearing on the diameter of the tubular film, which is the reason why this cooling means by the same applicant is also referred to as a calibrating means.

The above-discussed aspects and advantages of the plastic blend of PET with PVAL and/or PEBA may best be attained in combination with the nozzle blast drawing process and the subsequent rapid, intense cooling with the aid of the presently discussed calibrating means.

1. A single-layer or multilayer tubular food film that can be smoked and air-dried, in particular a sausage casing for smoked and/or air-dried sausage or meat goods, wherein the food film is manufactured of a homogeneous molten plastic material in an extrusion film blow molding plant extruding plastics supplied to a nozzle of a blow head and biaxially stretched in a triple-bubble process,
wherein:
the homogeneous molten plastic material is produced of a plastic blend of:
polyethylene terephthalate or a blend of various polyethylene terephthalates; and
polyvinyl alcohol; and/or
polyether block amide.

2. The single-layer or multilayer tubular food film that can be smoked and air-dried according to claim 1, wherein the plastic blend
includes:
a proportion of polyethylene terephthalate or a blend of various polyethylene terephthalates from 50 to 99% weight; and
a proportion of polyvinyl alcohol from 1 to 50% weight.

3. (canceled)

4. The single-layer or multilayer tubular food film that can be smoked and air-dried according to claim 1, wherein the food film exhibits a film thickness in a range from 10 to 50 μm, preferably from 15 to 30 μm, in particular at a caliber of up to 150 mm.

5. The single-layer or multilayer tubular food film that can be smoked and air-dried according to claim 1, wherein the food film exhibits a water vapor permeability of at least 1.5 kg/(m²·day) at a film thickness of 20 μm.

6. The single-layer or multilayer tubular food film that can be smoked and air-dried according to claim 1, wherein the food film exhibits a water vapor absorption of at least 0.4% weight, preferably in a range from 0.4 to 1.1% weight.

7. The single-layer or multilayer tubular food film that can be smoked and air-dried according to claim 1, wherein the food film exhibits a modulus of elasticity in a range from 2,000 to 3,000 N/mm².

8. The single-layer or multilayer tubular food film that can be smoked and air-dried according to claim 1, wherein the plastic blend includes at least one silicate.

9. The single-layer or multilayer tubular food film that can be smoked and air-dried according to claim 1, wherein the plastic blend includes at least one filler selected from a group consisting of corn starch, cellulose powder and micro glass beads.

10. The single-layer or multilayer tubular food film that can be smoked and air-dried according to claim 1, wherein the plastic blend includes at least one filler selected from a group consisting of chalk, talcum, salts and other mineral substances.

11. A method for the manufacture of a single-layer or multilayer tubular food film that can be smoked and air-dried, in particular a sausage casing for smoked and/or air-dried sausage or meat goods, wherein the sausage or meat goods are filled into the food film prior to smoking and/or air-drying,
the food film being manufactured of a homogeneous molten plastic material in a nozzle blast drawing process and under subsequent biaxial stretching in a triple-bubble process,
wherein
the molten plastic material is produced of
polyethylene terephthalate or a blend of various polyethylene terephthalates; and
polyvinyl alcohol; and/or
polyether block amide.

12. The method according to claim 11,
further comprising a proportion of polyethylene terephthalate or a blend of various polyethylene terephthalates from 50 to 99% weight; and
a proportion of polyvinyl alcohol from 1 to 50% weight.

13. (canceled)

14. The method according to claim 11, wherein a film thickness of the food film is adjusted in a range from 10 to 50 μm, preferably from 15 to 30 μm, in particular at a caliber of up to 150 mm.

15. The method according to claim 11, wherein the plastic blend is selected such that the food film exhibits a water vapor permeability of at least 1.5 kg/(m²·day) at a film thickness of 20 μm.

16. The method according to claim 11, wherein the plastic blend is selected such that the food film exhibits a water vapor absorption of at least 0.4% weight, preferably in a range from 0.4 to 1.1% weight.

17. The method according to claim 11, wherein the plastic blend is selected such that the food film exhibits a modulus of elasticity in a range from 2,000 to 3,000 N/mm².

18. The method according to claim 11, wherein at least one silicate is added to the plastic blend.

19. The method according to claim 11, wherein at least one filler selected from a group consisting of corn starch, cellulose powder and micro glass beads is added to the plastic blend.

20. The method according to claim 11, wherein at least one filler selected from a group consisting of chalk, talcum, salts and other mineral substances is added to the plastic blend.

21. The single-layer or multilayer tubular food film that can be smoked and air-dried according to claim 1, wherein the plastic blend includes: a proportion of polyethylene terephthalate or a blend of various polyethylene terephthalates from 70 to 99% weight; and a proportion of polyether block amide from 1 to 30% weight.

22. The single-layer or multilayer tubular food film that can be smoked and air-dried according to claim 1, wherein the plastic blend includes: a proportion of polyethylene terephthalate or a blend of various polyethylene terephthalates from 20 to 98% weight; a proportion of polyvinyl alcohol from 1 to 50% weight; and a proportion of polyether block amide from 1 to 30% weight.

23. The single-layer or multilayer tubular food film that can be smoked and air-dried according to claim 22 wherein the plastic blend includes: a proportion of polyethylene terephthalate or a blend of various polyethylene terephthalates from 55 to 90% weight, in particular from 60 to 75% weight; a proportion of polyvinyl alcohol from 5 to 30% weight, in particular from 15 to 25% weight, and a proportion of polyether block amide from 1 to 15% weight, in particular from 5 to 10% weight.

24. The method according to claim 11 further comprising: a proportion of polyethylene terephthalate or a blend of various polyethylene terephthalates from 70 to 99% weight; and a proportion of polyether block amide from 1 to 30% weight.

25. The method according to claim 11 further comprising: a proportion of polyethylene terephthalate or a blend of various polyethylene terephthalates from 20 to 98% weight; a proportion of polyvinyl alcohol from 1 to 50% weight; and a proportion of polyether block amide from 1 to 30% weight.

26. The method according to claim 25 wherein for the manufacture of the food film, a proportion of polyethylene terephthalate or a blend of various polyethylene terephthalates from 55 to 90% weight, in particular from 60 to 75% weight; a proportion of polyvinyl alcohol from 5 to 30% weight, in particular from 15 to 25% weight; and a proportion of polyether block amide from 1 to 15% weight, in particular from 5 to 10% weight is supplied.
